(19) United States
(12) Patent Application Publication
(10) Pub. No.: US 2013/0101913 A1
(43) Pub. Date: Apr. 25, 2013

(54) METHOD FOR OPERATING A FUEL CELL AND FUEL CELL SYSTEM WITH IMPROVED THERMAL CONTROL

(71) Applicant: Robert Bosch GmbH, Stuttgart (DE)

(72) Inventors: Ulrich Gottwick, Stuttgart (DE); Daniel Zirkel, Stuttgart (DE); Sebastian Hawliczek, Kornwestheim (DE)

(73) Assignee: ROBERT BOSCH GMBH, Stuttgart (DE)

(21) Appl. No.: 13/648,333

(22) Filed: Oct. 10, 2012

(30) Foreign Application Priority Data
Oct. 19, 2011 (DE) 102011084783.9

(51) Int. Cl. H01M 8/04

(52) U.S. Cl. CPC H01M 8/04701
USPC 429/433

(57) ABSTRACT

The present invention relates to a method for operating a fuel cell system, comprising the following method steps:
a) conducting a defined quantity of anode gas to an anode and conducting a defined quantity of cathode gas to a cathode, wherein a defined voltage is set at a defined current consumption and a defined power provision, wherein
b) in order to increase the waste heat of the fuel cell for a defined, temporally limited duration, the fuel cell is operated in a cathode gas depletion state.

Such a method provides improved thermal control of the fuel cell even in the case of coldstarting or after operation in the partial load mode. The present invention also relates to a fuel cell system.

### BACKGROUND OF THE INVENTION

The present invention relates to a method for operating a fuel cell and to a fuel cell system.

Fuel cells are promising energy sources. For example, the fuel cell based on pure hydrogen as combustion gas provides advantages since pure water is produced as emission. Furthermore, fuel cells can provide improved efficiency primarily in the partial load range in comparison with internal combustion engines, which can become noticeable in the consumption of the vehicle. Thus, the consumption of a mid-range vehicle operated using a fuel cell can be, for example, when converted, 3 liters of gasoline per 100 kilometers.

Owing to the good efficiency of fuel cells, the waste heat produced for example in the case of motor vehicles can under some circumstances only actually be sufficient for heating the driver's cab and/or keeping the fuel cell system warm, for example. In detail, under some circumstances in fuel cell systems which are operated over a relatively long period of time in the lower load range or under partial load, waste heat is only generated to a limited degree with electrical energy conversion. As a result, the driver's cab is under some circumstances only heatable to a limited extent or the fuel cell system can cool down. In this regard, a remedy can be provided by providing an auxiliary electric heater for the cab air and/or in the coolant.

Document U.S. Pat. No. 5,366,821 describes a fuel cell system in which a substantially constant output voltage can be provided. In order to respond to fluctuations in the output voltage of the fuel cell, in accordance with said document the pressure, the flow rate and the ratio of the reactants can be varied.

### SUMMARY OF THE INVENTION

The subject matter of the present invention is a method for operating a fuel cell system, comprising the following method steps:

a) conducting a defined quantity of anode gas to an anode and conducting a defined quantity of cathode gas to a cathode, wherein a defined voltage is set at a defined current consumption and a defined power provision, wherein

b) in order to increase the waste heat of the fuel cell for a defined, temporally limited duration, the fuel cell is operated in a cathode gas depletion state.

In method step a), the operating state of the fuel cell can be denoted as normal state. In this case, normal state can be understood in particular to mean that, taking into consideration the efficiency achievable with the fuel cell, an equilibrium or a defined dependency is set from various parameters. In detail, during normal operation of the fuel cell, operation usually proceeds with a superstoichiometric provision of anode gas and cathode gas, i.e. the fuel cell is always supplied with a sufficient quantity of reaction partners. This can mean in particular that sufficient operating gases are available at any point in time for the fuel cell to be able to operate as desired.

Suitable cathode gases may be in particular oxygen-containing gases, such as air, for example. Suitable anode gases may be in particular hydrogen-containing gases. In this case, both pure hydrogen and other gases which are converted into hydrogen for example via a reformation reaction, before they are conducted to the cathode may be suitable.

During normal operation of the fuel cell, a defined voltage can be set given a defined current consumption, with a defined power being provided. The preceding values can in this case in particular be denoted as being defined since they can in particular be matched to one another or be dependent on one another. Thus, for example, the voltage of the fuel cell can be reduced when more current is drawn and, in this case, the quantity of anode gas and cathode gas is sufficient.

During operation within this equilibrium, the fuel cell can operate at a specific efficiency taking into consideration any losses, such as parasitic losses, for example.

The present invention is based in particular on reducing the efficiency of the fuel cell in a targeted manner. In this way, an increased waste heat can be achieved, which can be used in a variety of ways. In accordance with method step b), the fuel cell can be operated in a cathode gas depletion state for a defined, temporally limited duration, for this purpose, i.e. in order to increase the waste heat of the fuel cell. In this case, method step b) can be operated prior to method step a), for example in the case of cold starting, or else after method step a), for example after operation of the fuel cell under partial load.

A cathode gas depletion state can in this case in particular be understood to mean an operating state of the fuel cell in which there is a departure from the abovementioned equilibrium or the abovementioned dependency. In detail, an under-supply of cathode gas can be brought about with respect to the equilibrium of cathode gas, current, voltage and power intentionally. In the context of the present invention, under-supply of cathode gas can in particular be understood to mean that the fuel cell, under given conditions, provides a lower power than would be possible with a normal supply, i.e. for example a markedly superstoichiometric supply of cathode gas. For example, starting from a cathode gas depletion state or an under-supply of cathode gas, whilst maintaining all other parameters, the power provided by the fuel cell can be increased by increasing the cathode gas inflow, which would not result in a power increase in the case of a normal supply, for example. In other words, in the depletion state less cathode gas can be supplied to the cathode than would be provided within the equilibrium or the optimum, in particular markedly superstoichiometric operation of the fuel cell.

In order to reduce the efficiency, the fuel cell can be switched over, for example, from the normal operating mode to the depletion operating mode, for a defined and temporally limited duration. By reducing the efficiency, the fuel cell can produce an increased quantity of waste heat as lost power since the quantity of electrical power which is in principle available and desired is reduced. This procedure does not result in any damage to the fuel cell. A fuel cell system according to the invention can rather provide a suitable and easily implementable possibility for being able to react immediately to any heat losses.

According to the invention, it is possible to achieve a situation in which sufficient waste heat of the fuel cell is present essentially at any time during the operation of the fuel cell for sufficiently heating a driver's cab of a vehicle, for example, or for preventing the fuel cell system from cooling down, This can ensure that the full or best-possible electrical energy can be made available, for example even during dispersal of a traffic jam on a highway, i.e. when the fuel cell system has been operated only on a low load for a relatively long period of time, or else at very low external temperatures.

As a result, a fuel cell system according to the invention can be kept at a sufficient temperature without needing to provide additional assemblies, such as an auxiliary electric heater. In addition, the additionally consumed fuel can be reduced since the operating point set on the gas side can be maintained. As a result, the parasitic power can also remain the same.

The consumption of a vehicle operated using a fuel cell can be further improved since the fuel required by auxiliary electric heaters, for example, can be saved. In this case, according to the invention, the parasitic powers can also be reduced or minimized.

Furthermore, the method according to the invention is implementable, in a particularly simple manner and without any substantial changes to existing fuel cell systems, into such fuel cell systems. It is possible, for example, for only one controller to be provided which produces the cathode gas depletion state in a suitable manner.

During implementation of the method according to the invention, in addition short flushing pulses can be advantageous in order to remove any quantities of liquid which have accumulated in the fuel cell or in the fuel cell stack from the system. As a result, the fuel cell system can be kept operational at any time. In this case, a flushing pulse can include in particular the passage of gas with a high mass flow. In order in the process to maintain the electrical power emission, the current can be reduced correspondingly during these flushing phases.

The method according to the invention is in this case implementable independently of the fuel cell system used, i.e. for example with high pressure, low pressure, stabilized intermediate-circuit voltage, with or without rechargeable battery, without any problems into such fuel cell systems.

In the context of one configuration, the depletion state can be achieved by reducing the mass flow of cathode gas at a constant power provision. If the cathode gas flow is reduced continuously with a constant withdrawal of electrical power from the fuel cell system, the above-described cathode gas depletion effects can arise, which can bring about a marked reduction in the efficiency. This configuration can provide a particularly convenient method since, at a constant power, only the mass flow can be reduced, which can remain wholly unnoticed to the driver of a vehicle, for example. In this case, more current can be drawn given a decreasing mass flow of cathode gas in particular in order to be able to draw the same electrical power. If the fuel cell is now operated in a depletion operating mode, more thermal energy can be generated. Parasitic powers, such as owing to the compressor power consumption for providing the cathode gas, can likewise be reduced in the process.

In the context of a further configuration, the mass flow of cathode gas is reduced down to a range which is equal to or greater than the stoichiometric range. As a result, the efficiency of the fuel cell system can be reduced in a suitable manner by virtue of a maximum possible cathode gas depletion state. In this case, it is still possible for sufficient power to be provided, but the waste heat can be increased in a suitable manner. In this case, the degree of reduction in the mass flow can be dependent on the respective starting point of the operating point. In detail, in the partial load range, operation usually proceeds at a very super stoichiometric level, with in this case a factor of 6 more cathode gas, such as air, for example, than is required being provided, for example. On full load, on the other hand, stoichiometry of approximately 2 is often used. Therefore, during normal operation in step a) during partial load operation, the mass flow of cathode gas can be reduced to a markedly greater extent than during normal operation under step a) during full-load operation. In the latter case, in this configuration a maximum reduction in the air mass flow of the cathode gas by a factor of 2 is particularly suitable. The stoichiometric range can in this case, in the context of the present invention, mean in particular operation in which the quantity of cathode gas molecules is provided precisely as can be consumed for the electrochemical reaction proceeding in the fuel cell.

In the context of a further configuration, the depletion state can be achieved by an increase in the current consumption at a constant mass flow of cathode gas. In this configuration, therefore, the mass flow of cathode gas can be kept constant and the current consumption increased in the process. In this case, the electrical power can likewise be increased. In this configuration, switchover from normal operation, i.e. method step a), to depletion operation, i.e. method step b) can take place in particular continuously.

In this case, an increase in the current consumption can be achieved in particular and by way of example by switching on an electrical load, such as the electric rear windshield heater, an electric air-conditioning compressor and/or an electric cab heater, for example. Thus, firstly electrical loads can be used under certain circumstances which are used by the driver of a vehicle independently of the depletion operating mode. In this case, only the mass flow of the cathode gas needs to be kept constant. Furthermore, switching on such electric loads does not result in any decrease in comfort and also does not impair the traffic safety. Parasitic powers, for example as a result of compressor power consumption, are in this case not additionally reduced by an increased current consumption of the load.

In the context of a further configuration, the depletion state can be achieved by increasing the mass flow of cathode gas with an additional increase in the current consumption. In this configuration, the increased quantity of waste heat results in particular from the simultaneous power increase of the fuel cell, which likewise corresponds to a greater power loss and to impairment of the efficiency. This configuration can therefore be advantageous in particular when the waste heat provided by an alternative embodiment is still insufficient. This can be the case, for example for the case of the use of the method according to the invention for a fuel cell arranged in a vehicle, for example, when the temperature of the fuel cell per se is still too low or the temperature of the coolant is reduced further and thus suitable heating is impossible. Even in this configuration, operation is possible in the depletion operating mode, wherein the electrically output power can remain constant or can increase only by the proportion of the increased parasitic power.

This configuration can be advantageous in particular in order to take possible system limits of the fuel cell system into consideration. Thus, a minimum fuel cell voltage can be provided, for example, which should not be undershot, for example owing to the transformation ratio of a DC-to-DC converter. In this case, in addition possible load reductions can be utilized. For example, when a lower system limit or voltage limit is reached, an additional load can be connected into the circuit.

In the context of a further configuration, the depletion state can be achieved by reducing the mass flow of cathode gas with a simultaneous increase in the current consumption provided. This a further advantageous embodiment for reducing the efficiency of the fuel cell in a desirable manner and for being able to produce an increased level of waste heat in the process. In this case, it is therefore possible to deviate from the pure depletion strategy by virtue of a reduction in the mass flow of cathode gas and also to increase the electrical emission power or current consumption.

In the context of a further configuration, method step b) can be initiated during starting of the fuel cell system. In particular it can often be the case when starting or starting up the fuel cell system that insufficient waste heat is still provided for heating a driver's cab sufficiently or for bringing the system to a suitable temperature. In this case, method step a) can therefore be implemented in particular after method step b), namely in particular when sufficient waste heat can be generated even during normal operation of the fuel cell.

In the context of a further configuration, method step b) can be initiated after operation of the fuel cell in method step a) under partial load. In particular under partial load, fuel cells can often have a particularly high efficiency. This advantage of the fuel cells can be desirable in principle, but, in particular in the case of low external temperatures, can result in the system cooling down and no longer providing the desired power. In addition, heating of a passenger interior can under some circumstances only be possible to a limited extent. The term partial load can in this case be understood in the context of the present invention in particular to mean a state which, in relation to the full load of the fuel cell, can purely be, for example, in a range of one third of the power scale for example at full load, without being restricted thereto.

The subject matter of the present invention is also a fuel cell system comprising at least one fuel cell with an anode and a cathode, wherein a defined voltage is set whilst supplying an anode gas to the anode and whilst supplying a cathode gas to the cathode at a defined current consumption and a defined power provision, and wherein the fuel cell is operable in a cathode gas depletion state for a defined, temporally limited duration in order to increase the waste heat of the fuel cell.

In the sense of the present invention, a fuel cell system can in this case in particular be a system which can be used for energy generation, wherein the energy generation is in particular achieved by means of a fuel cell. In the context of the present invention, this may include both a fuel cell system with only one fuel cell and a fuel cell system with a plurality of fuel cells, which can be arranged in a fuel cell stack, for example, and can be connected in parallel or in series. In this case, it is obvious to a person skilled in the art that the features described with respect to one fuel cell can be provided for any desired number of fuel cells or for all fuel cells together or in each case separately equally in the case of the provision of a plurality of fuel cells.

The fuel cell system according to the invention can in particular have the advantages described with reference to the method according to the invention. In particular, the fuel cell system according to the invention can make it possible in a simple manner to provide increased waste heat of the fuel cell. This can be used in particular for heating a driver's cab for the case in which the fuel cell system according to the invention is arranged in a motor vehicle. In addition, the additionally provided waste heat can be used, for example, for keeping the fuel cell system as such at a suitable temperature. It is thus possible, in particular when using a fuel cell system according to the invention in a vehicle, to ensure sufficient heatability of the passenger interior and sufficient heating of the system as such given relatively long operation under partial load and at low external temperatures. In this case, the consumption, in comparison with an embodiment which uses additional heating devices in accordance with the prior art, can be additionally reduced.

Therefore, a fuel cell system according to the invention can make both an additional contribution to comfort, to environment conditioning, and to the safety of a vehicle equipped with a fuel cell system according to the invention using very simple modification measures in comparison with conventional fuel cell systems. In this case, complex additional assemblies, such as heaters, can be dispensed with. As a result, a reduction in weight can be made possible, which further reduces consumption. Furthermore, the reliability of the fuel cell system according to the invention can be improved since additional component parts, such as an additional heater, for example, always entail the risk of damage or failure. Such risks can be avoided in accordance with the invention.

### BRIEF DESCRIPTION OF THE DRAWINGS

Further advantages and advantageous configurations of the subject matter according to the invention are illustrated by the drawings and explained in the description below. In this case, it should be noted that the drawings have only a descriptive character and are not envisaged to restrict the invention in any way. In the drawings

FIG. 1A shows a graph of the ratio of the current density in A/cm² (x axis) to the cell voltage in V (y axis).

FIG. 1B shows a graph of the ratio of the current density in A/cm² (x axis) to the electrical power density in W/cm² (y axis).

FIGS. 2A and 2B show graphs of power versus power loss for different power consumption levels.

### DETAILED DESCRIPTION

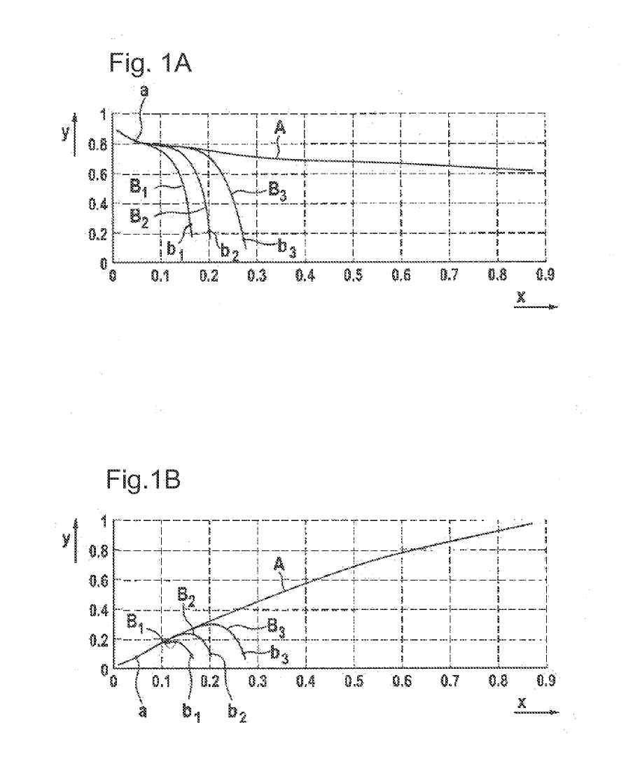

FIGS. 1A and 1B show graphs illustrating the ratio between the current density and the voltage and electrical power in a normal operating mode and in a depletion operating mode. In this case, FIG. 1A shows the ratio of the current density in A/cm² (x axis) to the cell voltage in V (y axis), and FIG. 1B shows the ratio of the current density in A/cm² (x axis) to the electrical power density in W/cm² (y axis).

The graphs in FIGS. 1A and 1B firstly show the response of a fuel cell system when the fuel cell is always supplied to a sufficient extent with the reaction partners, i.e. with anode gas and cathode gas (lines A) and the response of the fuel cell in a cathode gas depletion operating mode (lines B).

In respect of a normal operating mode, it can be seen here from FIG. 1A that a defined cell voltage is set depending on electrical current. In this case, FIG. 1A shows the typical voltage profile of a fuel cell over current density. The more current is output by the fuel cell, the lower the voltage becomes. However, in the process the electrical power provided increases, as can be seen from the graph in FIG. 1B.

With respect to a cathode gas depletion state, in this case the lines B show clearly that the voltage decreases to a much greater extent, which brings about a much steeper bend in the U/I characteristic, or the power can be kept constant (lines B). For example, this state can be achieved by continuously reducing the air mass flow of cathode gas at a constant consumption of electrical power from the system.

In addition, an operating state in which the fuel cell system is operated in a normal state is also referred to as a, whereas different depletion states are described as b₁-b₃. The lines B₁, B₂ and B₃ in this case result, for example, from different air mass flows of the cathode gas. For example, B₂ can mean a constant mass flow with simultaneous increase in the current. In addition, B₁ can correspond to an air mass flow reduction of the cathode gas with simultaneous increase in current, wherein B₃ can correspond to the simultaneous increase in mass flow of the cathode gas and current consumption, wherein the predesignated effects are illustrated purely schematically and are not restrictive. If, for example, the operating point b₁ is approached, it is thus necessary for more current to be drawn, for example with decreasing mass flow of cathode gas, wherein the same power in comparison with the normal state a is provided. In this case, considerably more thermal energy is produced which can be used, for example, for keeping the fuel cell system warm or for heating the passenger interior.

In principle, setting of a depletion state can take place continuously. Since in this case, however, as can be seen from lines B in FIG. 1B, the electrical power first increases, the setting of a cathode gas depletion state for the case in which an even short-term power increase is undesirable or is not possible, a discontinuous jump for example from point a to the desired depletion state, such as point b₁, can also take place.

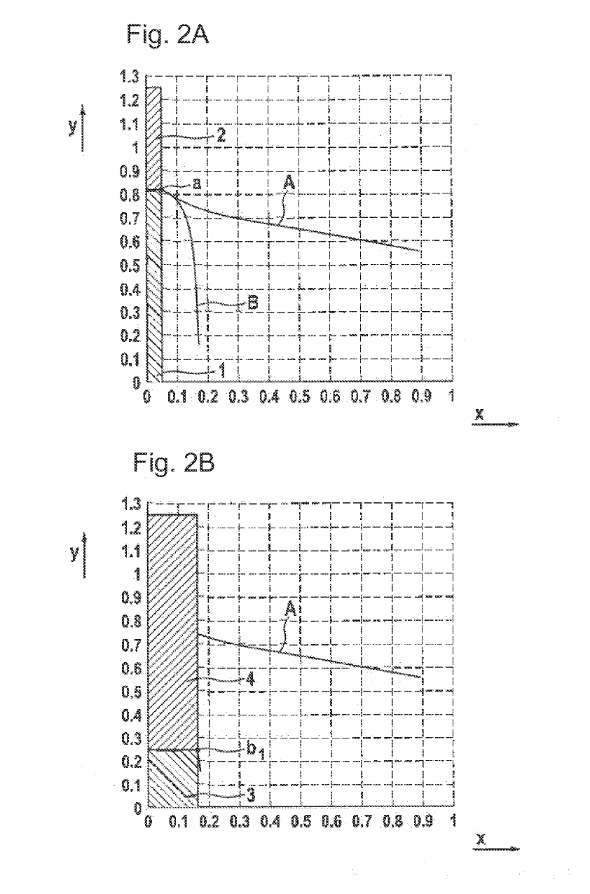

This effect of setting a cathode gas depletion state can be illustrated by way of example by the U/I characteristic in FIGS. 2A and 2B. The electrical power results from the multiplication of the current and the voltage (P_{electrical}=U_{BZ}×I_{BZ}), where P_{electrical} means the electrical power, U_{BZ} means the cell voltage of the fuel cell and I_{BZ} means the current of the fuel cell.

The electrical power P_{electrical} in this case corresponds to the area 1 below the operating point a shown in FIG. 2A. The power loss corresponds to the area 2 and can likewise be expressed as a multiplication, with the voltage resulting as the difference between the thermal emf of the upper or lower heating value U₀ and the present cell voltage U_{BZ} (Pₗₒₛₛ=(U₀−U_{BZ})×I_{BZ}). With respect to one example of a fuel cell in which water is produced, the upper heating value relates to water in vapor form and the lower heating value relates to liquid water. In this case, the upper or lower heating value results, as is known from the literature, at 1.253 V (lower heating value) and 1.487 V (upper heating value). The power loss can thus be calculated.

As shown in FIG. 2B, the electrical power P_{electrical} corresponds to the area 3 below the operating point b₁. The power loss corresponds to the area 4. In the case of the example illustrated with the two operating points a and b₁ of identical power, the power loss can be increased by a factor of 8, whereas the consumption is approximately three times as high. When using an auxiliary electric heater, as is known from the prior art, the consumption is increased owing to the efficiency of the heater and owing to increased parasitic losses. The latter are necessary for operating the fuel cell at the increased operating point.

1. A method for operating a fuel cell system, the method comprising:
a) conducting a defined quantity of anode gas to an anode and conducting a defined quantity of cathode gas to a cathode, wherein a defined voltage is set at a defined current consumption and a defined power provision, wherein
b) in order to increase the waste heat of the fuel cell for a defined, temporally limited duration, the fuel cell is operated in a cathode gas depletion state.

2. The method according to claim 1, wherein the depletion state is achieved by reducing the mass flow of cathode gas at a constant power provision.

3. The method according to claim 2, wherein the mass flow of cathode gas is reduced down to a range which is equal to or greater than the stoichiometric range.

4. The method according to claim 1, wherein the depletion state is achieved by increasing the current consumption given a constant mass flow of cathode gas.

5. The method according to claim 4, wherein an increase in the current consumption is achieved by switching on an electrical load.

6. The method according to claim 5, wherein the electrical load is an electric rear windshield heater, an electric air-conditioning compressor and/or an electric cabin heater.

7. The method according to claim 5, wherein the electrical load is an electric air-conditioning compressor.

8. The method according to claim 5, wherein the electrical load is an electric cabin heater.

9. The method according to claim 5, wherein the electrical load is an electric rear windshield heater, an electric air-conditioning compressor and an electric cabin heater.

10. The method according to claim 1, wherein the depletion state is achieved by increasing the mass flow of cathode gas with an additional increase in the current consumption.

11. The method according to claim 1, wherein the depletion state is achieved by reducing the mass flow of cathode gas with a simultaneous increase in the current consumption.

12. The method according to claim 1, wherein method step b) is initiated during starting of the fuel cell system.

13. The method according to claim 1, wherein method step b) is initiated after operation of the fuel cell in method step a) under partial load.

14. A fuel cell system comprising at least one fuel cell with an anode and a cathode, wherein a defined voltage is set whilst supplying an anode gas to the anode and whilst supplying a cathode gas to the cathode at a defined current consumption and a defined power provision, and wherein the fuel cell is operable in a cathode gas depletion state for a defined, temporally limited duration in order to increase the waste heat of the fuel cell.
